(19) United States
(12) Patent Application Publication
(10) Pub. No.: US 2019/0026306 A1
(43) Pub. Date: Jan. 24, 2019

(54) ONLINE INSTANTIABLE MESSAGE REPOSITORY PROCESSING APPARATUS AND METHOD

(71) Applicants: Jae Ho CHOI, Seoul (KR); DELTA PDS CO., LTD., Seoul (KR)

(72) Inventor: Jae Ho CHOI, Seoul (KR)

(73) Assignees: DELTA PDS CO., LTD., Seoul (KR); Jae Ho Choi, Seoul (KR)

(21) Appl. No.: 16/037,553

(22) Filed: Jul. 17, 2018

(30) Foreign Application Priority Data
Jul. 18, 2017 (KR) 10-2017-0090759
Jun. 15, 2018 (KR) 10-2018-0068961

(51) Int. Cl. G06F 17/30; H04L 12/58; H04L 29/06

(52) U.S. Cl. CPC G06F 17/30165; H04L 51/16; H04L 51/046; G06F 17/30203; G06F 17/30377; G06F 17/30115; H04L 65/403

(57) ABSTRACT

Provided is an online instantiable message repository processing apparatus and method. The online instantiable message repository processing apparatus includes a memory and a processor electrically connected to the memory. Here, the processor receives an open request of an online instantiable message repository which is instantiable into a chat room participated by at least one participant and associated with a conversation thread and implemented as a computer file, resumes the chat room when the online instantiable message repository is successfully opened, and updates the online instantiable message repository when a conversation message including a message sender and a message content is added to the chat room associated with the conversation thread.

### CROSS-REFERENCE TO RELATED APPLICATIONS

This U.S. non-provisional patent application claims priority under 35 U.S.C. § 119 of two Korean Patent Applications 1) No. 10-2017-0090759, filed on Jul. 18, 2017 and 2) No. 10-2018-0068961, filed on Jun. 15, 2018, the entire contents of which are hereby incorporated by reference.

### BACKGROUND OF THE INVENTION

The present invention disclosed herein relates to an online instantiable message repository processing technology, and more particularly, to an online instantiable message repository processing apparatus and method which can allow users to efficiently share the overall communication process through a repository that can be instantiated as an online chat room and stores past messages.

The Internet messenger corresponds to an application for delivering a message including characters or graphics between users, and can be implemented as a chat room in which a plurality of users participate. In one embodiment, an Internet messenger may include a mobile messenger performed in a mobile environment (e.g., a mobile phone), and may include, for example, Kakao Talk, LINE, WeChat, and Facebook messenger.

As the number of users using the Internet messengers is rapidly increasing, a variety of applications used in the mobile environment are being developed. Among them, programs for sharing files are being used by many users.

### SUMMARY OF THE INVENTION

The present invention provides an online instantiable message repository processing apparatus and method which can efficiently share the overall communication process between users through a repository that can be instantiated as an online chat room and stores past messages.

The present invention also provides an online instantiable message repository processing apparatus and method which allows a new participant or an old participant who has left a chat room to access a computer file and to easily participate in a chat room including all of past conversation messages through an online instantiable message repository.

The present invention also provides an online instantiable message repository processing apparatus and method which can increase user convenience by applying an online instantiable message repository managed as a computer file that can be shared between users and thus allowing a chat room to be shared and managed through a more intuitive interface.

Embodiments of the present invention provide online instantiable message repository processing apparatuses including a memory and a processor electrically connected to the memory, wherein the processor: receives an open request of an online instantiable message repository which is instantiable into a chat room participated by at least one participant and associated with a conversation thread and implemented as a computer file; resumes the chat room when the online instantiable message repository is successfully opened; and updates the online instantiable message repository when a conversation message including a message sender and a message content is added to the chat room associated with the conversation thread.

The processor may grant a file control authority of the online instantiable message repository to a chat room creator.

The processor may grant a file read authority of the online instantiable message repository to the at least one participant participating via the online invitation.

The processor may manage a folder object including the online instantiable message repository together with a common file object as a shared folder of the at least one participant.

The processor may request the chat room creator to approve deletion of the online instantiable message repository when participation of all the participants in the chat room is terminated.

The processor may determine whether or not a requester corresponds to one of the at least one participant and approve the open request when the open request is received.

The processor may reverse-sequentially provide a portion of the conversation threads to the corresponding requester at a specific time interval unit in the online repository capable message repository when the open request is approved.

The processor may allow the at least one participant to share real-time manipulation or real-time modification of a common file object when a conversation message in the conversation thread is associated with the common file object.

When the conversation message is added, the processor may immediately provide the added conversation message to the at least one participant such that the participant internally opens the online instantiable message repository.

Whenever the conversation message is added, the processor may reflect the number of online instantiable message repositories including unconfirmed conversation messages not confirmed by a user among all online instantiable message repositories in the corresponding folder object and the sub-folder object thereof or the number of unconfirmed conversation messages not confirmed by a user in the folder object.

The processor may receive a transferred file object transferred from one of the at least one participant through the chat room as the conversation message.

The processor may automatically add the transferred file object to a corresponding folder object as a common file object and associates the conversation message with the transferred file object.

The processor may receive, from a work creator corresponding to one of the at least one participant through the chat room, a work object including a work content and work processor and fed back by the work processor as the conversation message.

The processor may detect a work object satisfying a remind condition among the work objects of all online instantiable message repositories in the folder object at a specific time period and reflect the work object in a today work list in the folder object.

The processor may allow a statistic calculation result calculated based on at least one of the number of creations regarding all the online instantiable message repositories, common file objects and sub-folder objects which have association of a subtree structure with a folder object, the creator, and the participant to be included in an accumulated statistic count in the corresponding folder object.

The processor may perform statistic calculation based on at least one of the number of creations, the number of processing, the work creator, and the work processor regarding the work objects associated with all of the corresponding online instantiable message repositories, and may reflect a statistic calculation result in the accumulated statistic count.

The processor may determine the activity of the online instantiable message repository object 320 based on the update frequency of the conversation thread or the number of created work objects to determine the sorting order of the online instantiable message repository in the corresponding folder object.

When receiving a delete request for a common file object from a folder sharer regarding a folder object, the processor may approve the delete request based on the association with the online instantiable message repository in the corresponding folder object and the common file object.

When a move request from the corresponding folder object (hereinafter, referred to as a first folder object) to another folder object (hereinafter, referred to as a second folder object) with respect to the online instantiable message repository, the common file object, or the sub-folder object is received, the processor may re-associate a target object requested to move and all other objects associated therewith with the first and second folder objects.

In other embodiments of the present invention, methods of processing an online instantiable message repository performed in an online instantiable message repository processing apparatus including a memory and a processor electrically connected to the memory, includes: receiving an open request of an online instantiable message repository which is instantiable into a chat room participated by at least one participant and associated with a conversation thread and implemented as a computer file; resuming the chat room when the online instantiable message repository is successfully opened; and updating the online instantiable message repository when a conversation message including a message sender and a message content is added to the chat room associated with the conversation thread.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating an online instantiable message repository processing system according to an embodiment of the present invention;

FIG. 2 is a view illustrating an online instantiable message repository processing apparatus of FIG. 1;

FIG. 3 is a view illustrating a data structure of a memory of FIG. 2;

FIG. 4 is a view illustrating a functional element of a processor of FIG. 2;

FIG. 5 is a flowchart illustrating a message-based file sharing procedure performed by the processor of FIG. 2;

FIG. 6 is a view illustrating a process of providing, by a user terminal, a file sharing interface in linkage with an online instantiable message repository processing apparatus according to an embodiment of the present invention; and

FIG. 7 is a view illustrating a process of visualizing, by a user terminal, an online instantiable message repository to a chat room in linkage with an online instantiable message repository processing apparatus.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, it will be described about an exemplary embodiment of the present invention in conjunction with the accompanying drawings.

The description of the present invention is merely an example for structural or functional explanation, and the scope of the present invention should not be construed as being limited by the embodiments described in this disclosure. That is, the embodiments are to be construed as being variously embodied and having various forms, such that the scope of the present invention should be understood to include equivalents capable of realizing technical spirit. Since the object or effect of the present invention is not intended to be limited to a specific embodiment, it should be understood that the scope of the present invention should not be construed as being limited thereto.

Meanwhile, the meaning of the terms described in the present application should be understood as follows.

The terms “first”, “second” and the like are intended to distinguish one element from another, and the scope of the right should not be limited by these terms. For example, the first component may be referred to as the second component, and similarly, the second component may also be referred to as the first component.

It is to be understood that when an element is referred to as being “connected” to another element, it may be directly connected to the other element, but other elements may be present in between. On the other hand, when an element is referred to as being “directly connected” to another element, it should be understood that there are no other elements in between. On the other hand, other expressions that describe the relationship between components such as “between” and “just between” or “neighboring to” and “directly adjacent to” should be similarly interpreted as well.

It should be understood that the singular forms include the plural forms unless the context clearly dictates otherwise, and the terms “include” or “have” is intended to specify the presence of one or embodied features, numbers, steps, operations, elements, parts, or combinations thereof, and should not be understood as excluding the presence or additional possibility of one or more other features, numbers, steps, operations, elements, parts, or combinations thereof in advance.

In each step, the identification code (e.g., a, b, c, etc.) is used for convenience of explanation. The identification codes do not describe the order of the steps, and unless otherwise stated, the respective steps may occur differently from the specified order. That is, each step may occur in the same order as described, may be performed substantially concurrently, or may be performed in reverse order.

The present invention can be embodied as computer-readable code on a computer-readable recording medium, and the computer-readable recording medium includes any type of recording device for storing data that can be read by a computer system. Examples of the computer-readable recording medium include ROM, RAM, CD-ROM, magnetic tape, floppy disk, optical data storage, and the like. In addition, the computer-readable recording medium may be distributed over a network-connected computer system such that computer readable code can be stored and executed in a distributed manner.

Unless defined otherwise, all terms used herein have the same meaning as commonly understood by one of ordinary skill in the art to which the present invention belongs. The terms defined in commonly used dictionaries should be interpreted to be consistent with the meaning in the context of the related art and cannot be interpreted as having ideal or overly formal meaning unless explicitly defined in the present application.

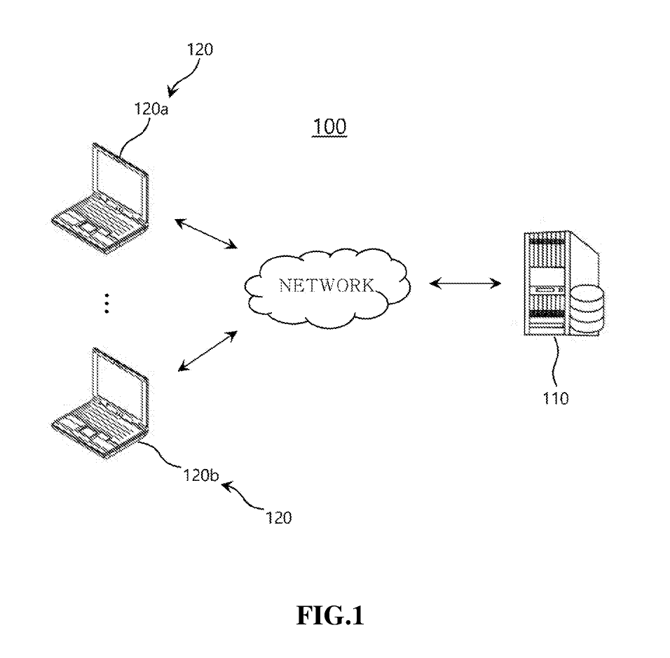

FIG. 1 is a view illustrating an online instantiable message repository processing system according to an embodiment of the present invention.

Referring to FIG. 1, an online instantiable message repository processing system 100 includes an online instantiable message repository processing apparatus 110 and user terminals 120, which may be connected via a network.

The online instantiable message repository processing apparatus 110 corresponds to a computing device that may be connected to the user terminal 120. In one embodiment, the online instantiable message repository processing apparatus 110 may manage at least one group of members including users associated with the user terminals 120 as the members, and may manage a conversation thread grouping messages sent from a member group constituted through at least one user terminal 120. In one embodiment, the conversation thread may be implemented in a chat room of an Internet messenger.

In one embodiment, the online instantiable message repository processing apparatus 110 may be connected to the user terminal 120 through a message agent installed in the user terminal 120. In one embodiment, when installed in the user terminal 120, the message agent may be implemented in software such that the user terminal 120 and the online instantiable message repository processing apparatus 110 are connected to and interwork with each other via the network with the approval of the user terminal 120.

The user terminal 120 corresponds to a computing device connected to the online instantiable message repository processing apparatus 110, and may be implemented, for example, as a desktop, notebook, tablet PC, or smart phone. In one embodiment, a first user terminal 120a may correspond to a mobile terminal, and may be connected to the online instantiable message repository processing apparatus 110 via cellular communication or Wi-Fi communication. In another embodiment, a second user terminal 120b may correspond to a desktop, and may be connected to the online instantiable message repository processing apparatus 110 via the Internet.

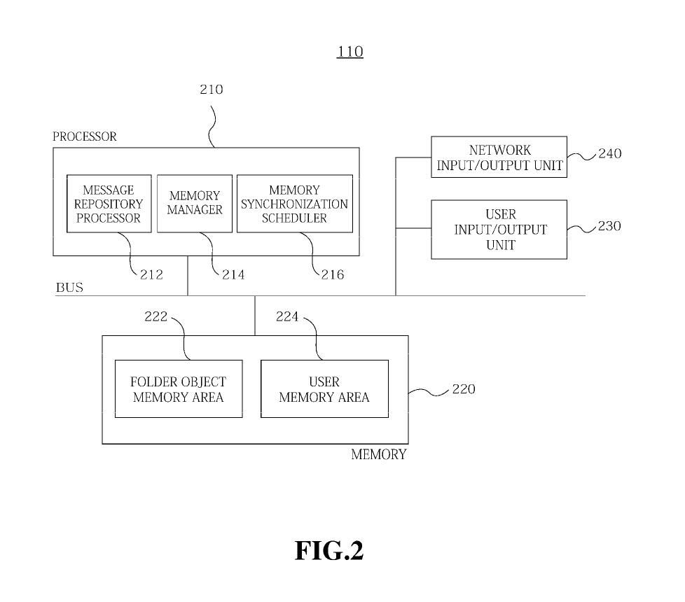

FIG. 2 is a view illustrating an online instantiable message repository processing apparatus of FIG. 1.

Referring to FIG. 2, the online instantiable message repository processing apparatus 110 may include a processor 210, a memory 220, a user input/output unit 230, and a network input/output unit 240.

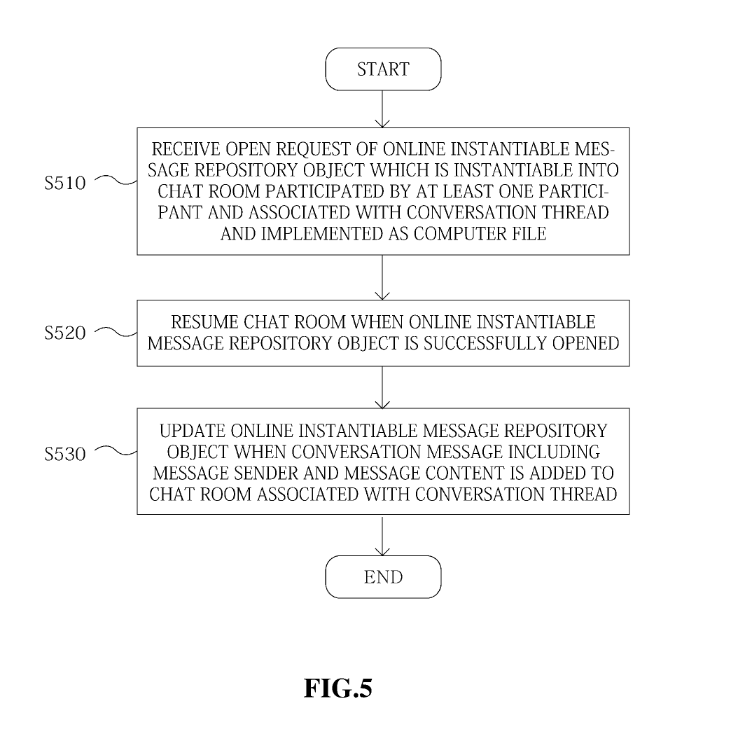

The processor 210 includes a message repository processor 212 that can execute an online instantiable message repository process of FIG. 5, a memory manager 214 that can manage the memory 220 that is read or written by the message repository processor 212, and a memory synchronization scheduler 216 that can schedule the synchronization time between a volatile memory and a nonvolatile memory in the memory 220. The processor 210 may control the overall operation of the online instantiable message repository processing apparatus 110, and may control the data flow among the memory 220, the user input/output unit 230 and the network input/output unit 240. The processor 210 may be implemented with a Central Processing Unit (CPU) of the online instantiable message repository processing apparatus 110.

The memory 220 may include an auxiliary storage that is implemented with a nonvolatile memory such as a Solid State Disk (SSD) or a Hard Disk Drive (HDD) to store entire data necessary for the online instantiable message repository processing apparatus 110, and may include a main storage that is implemented with a volatile memory such as a Random Access Memory (RAM). Thus, the memory 220 may be implemented with volatile and nonvolatile memories, and may be implemented to be connected via a hyperlink if implemented with a nonvolatile memory.

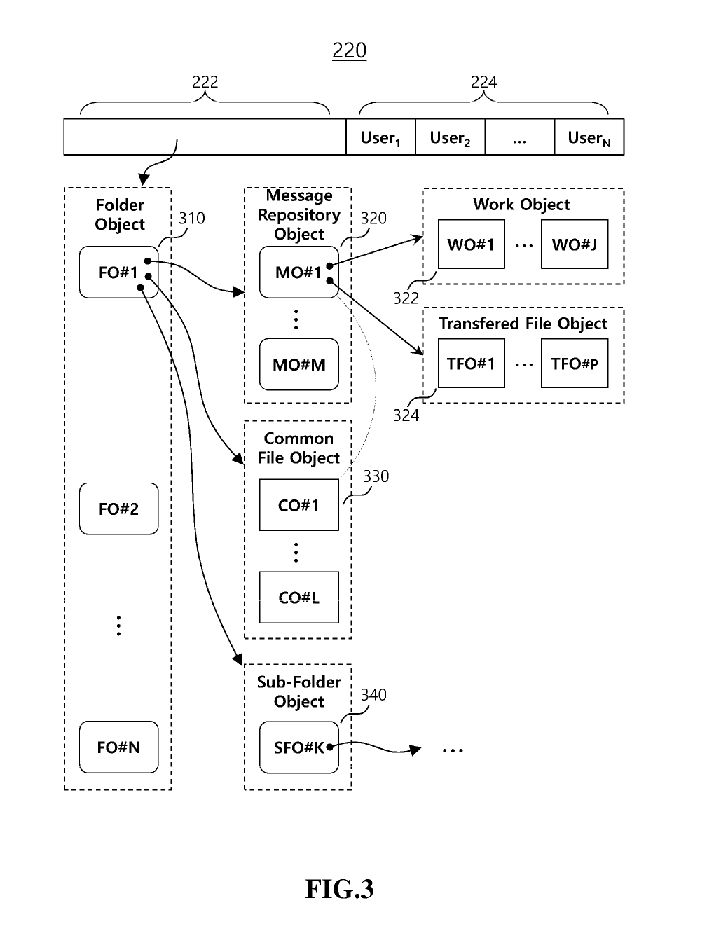

The memory 220 may include a folder object memory area 222 and a user memory area 224. This will be described with reference to FIG. 3.

FIG. 3 is a view illustrating a data structure of a memory of FIG. 2.

A folder object 310 may be stored in the folder object memory area 222. The folder object memory area 222 includes an online instantiable message repository object memory area associated with an online instantiable message repository object 320 in the folder object 310, a common file object memory area associated with a common file object 330 in the folder object 310, and a sub-folder object memory area associated with a sub-folder object 340 in the folder object 310. Also, at least one work object 322 and transferred file object 324, which may be associated with the online instantiable message repository object 320 one-to-many, may be stored in the online instantiable message repository object memory area. For example, a folder object FO#1 stored in the folder object memory area 222 may include an online instantiable message repository object MO#1, a common file object CO#1, and a sub-folder object SFO#, and the online instantiable message repository object MO#1 may include work objects WO#1 and WO#2 and a transferred file object TFO#1 (N, M, L, K, J, and P in FIG. 3 are natural numbers, and may have the same or different values from one another).

The user memory area 224 is associated with user information associated with the user terminal 120. Here, the user information may include at least one of a user's name (screen name), a messenger ID, a password, a member group affiliated as a member, a participating project, and work evaluation point information.

The user input/output unit 230 includes an environment for receiving a user input and an environment for outputting specific information (e.g., project evaluation data) to a user, and may include an input device including an adapter such as a mouse, a trackball, a touchpad, a graphic tablet, a scanner, a touch screen, a keyboard or a pointing device, and an output device including an adapter such as a monitor or a touch screen. In one embodiment, the user input/output unit 230 may correspond to a computing device connected via a remote connection, and in such case, the online instantiable message repository processing apparatus 110 may perform as a server.

The network input/output unit 240 includes an environment for connecting to the user terminal 120 through a network, and may include an adapter for Local Area Network (LAN) communication.

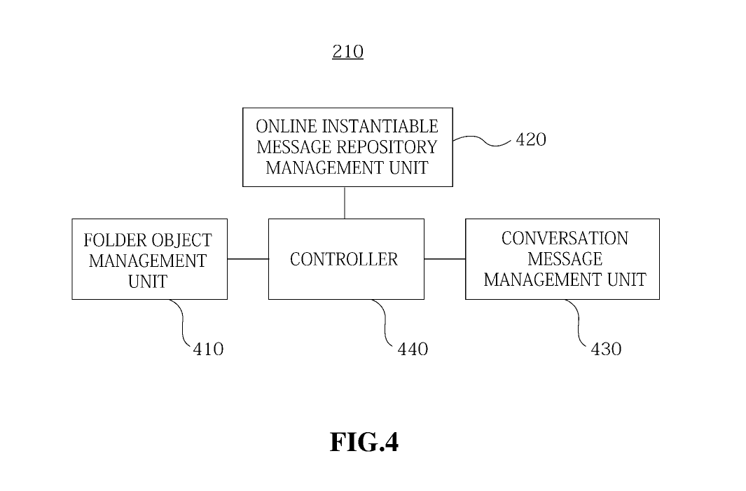

FIG. 4 is a view illustrating a functional element of a processor of FIG. 2.

Referring to FIG. 4, the processor 210 may include a folder object management unit 410, an online instantiable message repository management unit 420, a conversation message management unit 430, and a controller 440.

The folder object management unit 410 manages the folder object 310 including the online instantiable message repository object 320 and the common file object 330. Here, the online instantiable message repository object 320 may be instantiated into a chat room in which at least one participant participates and which is associated with a conversation thread, and may be implemented with a computer file. In one embodiment, the common file object 330 may correspond to a common computer file object such as a document file or a multimedia file which can be transferred from the user terminal 120.

More specifically, the folder object management unit 410 may generate a folder object 310 including at least one container of the online instantiable message repository object 320, the common file object 330 and the sub-folder object 340 in the folder object memory area 222, may manage the modification and deletion of the generated folder object 310, and may verify the access right of a user to determine whether or not the corresponding access is allowed when the access to the corresponding folder object 310 is attempted by the user terminal 120 associated with the corresponding user.

The folder object management unit 410 may manage the online instantiable message repository object 320 in the folder object 310 as an independent file object distinguished from the common file object 330. In one embodiment, the folder object management unit 410 may manage the folder object 310 hierarchically configured through the online instantiable message repository object 320, the common file object 330, and the sub-folder object 340.

In one embodiment, when the folder object 310 is created by a folder creator, the folder object management unit 410 may grant the folder creator the access right of the folder creator, and may grant the access right of a folder sharer to each of at least one user designated as a sharing target for the corresponding folder object 310 by the corresponding folder creator and the corresponding folder creator. The folder object management unit 410 may access the corresponding folder object 310 through the access right of the folder creator or the folder sharer when the access to the folder object 310 is attempted.

In one embodiment, when the access to a specific folder object 310 is attempted, the folder object management unit 410 checks the access right of the corresponding access attempter to the corresponding folder object 310 to determine whether to provide a file list for accessing the online instantiable message repository object 320, the common file object 330 and the sub-folder object 340 in the corresponding folder object 310, and may receive an access or open request for a specific file object from the user terminal 120 through the corresponding file list. In one embodiment, the folder object management unit 410 may together display whether or not each file object is accessible to the user terminal 120 through the file list in the corresponding folder object 310.

In one embodiment, the folder object management unit 410 may request the approval of deletion of the online instantiable message repository object 320 from a chat room creator when participation of all participants in the corresponding chat room is finished. For example, when all the participants participating in the chat room where the online instantiable message repository object 320 is instantiated exit from the corresponding chat room, the folder object management unit 410 may delete the corresponding online instantiable message repository object 320 from the corresponding folder object 310 according to the approval of the chat room creator. Participant-related contents related to the online instantiable message repository object 320 will be described in more detail in the description of the online instantiable message repository management unit 420.

In one embodiment, when a delete request related to the common file object 330 in the folder object 310 is received from the folder sharer related to the folder object 310, the folder object management unit 410 may approve the corresponding delete request based on the association of the corresponding file object 330 and the online instantiable message repository object 320 in the corresponding folder object 310. For example, in the case of a regular file object 330 associated with a particular online instantiable message repository object 320, the folder object management unit 410 cannot delete the corresponding common file object 330 until the corresponding online instantiable message repository object 320 is deleted. Association-related contents related to the online instantiable message repository object 320 will be described in more detail in the description of the online instantiable message repository management unit 420.

In one embodiment, when a move request from the corresponding folder object (hereinafter, referred to as a first folder object) to another folder object (hereinafter, referred to as a second folder object) with respect to the online instantiable message repository object 320, the common file object 330, or the sub-folder object 340 is received, the folder object management unit 410 may re-associate the target object requested to move and all its associated objects with the corresponding first and second folder objects. For example, referring to FIG. 3, in regard to an online instantiable message repository object MO#1 present in the first folder object FO#1 and associated with the common file object CO#1, the folder object management unit 410 may receive a move request for moving the online instantiable message repository object MO#1 from the first folder object FO#1 to the second folder object FO#2 from the user terminal 120 associated with one of the participants of the corresponding chat room, in accordance with the move request, may release the association between both the online instantiable message repository object MO#1 and the common file object CO#1 associated therewith and the first folder object FO#1, and may establish the association with the second folder object FO#2. Similarly, when a move request for moving the common file object CO#1 from the first folder object FO#1 to the second folder object FO#2 is received, the folder object management unit 410 may release the association between both the common file object CO#1 and the instantiable message repository objects MO#1 associated therewith and the first folder object FO#1 and establish the association with the second folder object FO#2. That is, when a movement of a specific instant online message repository 320, common file object 330 or sub-folder object 340 in the folder object 310 occurs, the folder object management unit 410 may control such that the target object requested to move and other target objects associated therewith are moved together.

In the above embodiment, when the move requester and the creator of the target object requested to move are different, the folder object management unit 410 may determine whether to perform the corresponding movement under the approval of the creator of the target object requested to move or the folder creator related to the corresponding folder object 310.

The online instantiable message repository management unit 420 may grant a file control authority of the online instantiable message repository object 320 to a chat room creator. In addition, the online instantiable message repository management unit 420 may grant a file read authority to read the file of the message repository object 320 to at least one participant participating through the online invitation. In one embodiment, when the online instantiable message repository object 320 is created by the chat room creator, the online instantiable message repository management unit 420 may determine at least one participant participating in the corresponding online instantiable message repository object 320 via a user invitation. In one embodiment, when a request to create an online instantiable message repository within the folder object 320 is received from the user terminal 120 associated with the folder sharer related to the folder object 310, the online instantiable message repository management unit 420 may create an actual online message repository object 320 participated by at least one participant designated by the corresponding folder sharer, and may include the actual online message repository object 320 in the corresponding folder object 310.

In one embodiment, the online instantiable message repository management unit 420 may manage the folder object 310 including the online instantiable message repository object 320 together with the common file object 330 as a shared folder of at least one participant. Also, the online instantiable message repository management unit 420 may approve a based on whether or not the corresponding request related to the user invitation is performed on a folder sharer regarding the folder object 310. For example, the online instantiable message repository management unit 420 may invite at least one of the folder sharers regarding the folder object 310 in the user invitation process by the chat room creator, and accordingly, the chat room creator may select and invite one of the folder sharers participating in the corresponding folder object 310. In one embodiment, the online instantiable message repository management unit 420 may create an online instantiable message repository object 320 associated with a specific common file object 330 present in the folder object 310 based on the user's request. For example, the online instantiable message repository management unit 420 may receive a create request of the online instantiable message repository object 320 associated with a specific common file object (e.g., minutes document file) 330 present in the corresponding folder object 310 from the chat room creator who is one of the folder sharers of the folder object 310, and may create an online instantiable message repository object 320 that can be instantiated into a chat room participated by at least one participant designated by the chat room creator among the corresponding folder sharers to associate the online instantiable message repository object 320 with the common file object 330. In one embodiment, when the online instantiable message repository object 320 associated with the specific common file object 330 is created, the online instantiable message repository management unit 420 may add the corresponding common file object 330 to the corresponding conversation thread as a multimedia message or an attachment file message. Also, when the corresponding addition is successfully performed, the online instantiable message repository management unit 420 may release the association with the corresponding online instantiable message repository object 320 and the corresponding common file object 330.

The online instantiable message repository management unit 420 may receive an open request of the online instantiable message repository object 320. The online instantiable message repository management unit 420 may receive an open request the online instantiable message repository object 320 in the folder object 310 from one of the folder sharers that can access the folder object 310.

When the open request of the online instantiable message repository object 320 is received, the online instantiable message repository management unit 420 may determine whether the corresponding requester is one of at least one participant participating in the corresponding online instantiable message repository object 320 and approve the corresponding opening. That is, the online instantiable message repository management unit 420 may approve the opening of the corresponding online instantiable message repository 320 only to the participants of the corresponding chat room.

In one embodiment, the online instantiable message repository management unit 420 may provide an open permission request message regarding the corresponding online instantiable message repository object 320 to the corresponding chat room creator or participant under the control of the corresponding requester if the corresponding open request is not approved, and when an open request response message by the chat room creator or the participant is received as an approval response thereto, the online instantiable message repository management unit 420 may partially approve the corresponding open request such that the requester opens the corresponding online instantiable message repository object 320 as read-only.

In one embodiment, the online instantiable message repository management unit 420 may provide a participation request message for the corresponding online instantiable message repository object 320 to the corresponding chat room creator or participant under the control of the corresponding requester if the corresponding open request is not approved, and when a participation request response message by the chat room creator or the participant is received as an approval response thereto, the online instantiable message repository management unit 420 may set the corresponding requester as a participant in the corresponding chat room.

When the corresponding open request is approved, the online instantiable message repository management unit 420 may inversely and sequentially provide a portion of request threads to the corresponding requester in a specific time interval unit in the corresponding online instantiable message repository object 320. More specifically, the online instantiable message repository management unit 420 may first provide, to the user terminal 120 of the corresponding requester, a first partial conversation thread reverse-sequentially formed in the latest added conversation message among the corresponding conversation thread to the user terminal 120 through reverse sequentially processing in which the conversation threads of the corresponding online instantiable message repository object 320 are sequentially processed in reverse order when the corresponding opening is approved, and may reverse-sequentially provide second and third partial conversation threads continuing according to the access attempt to the conversation messages created before the first partial conversation thread. Accordingly, the online instantiable message repository management unit 420 may instantiate the corresponding conversation threads to the chat room in the order of partial conversation threads that are reverse-sequentially provided in the process of opening, by the user terminal 120, the corresponding online instantiable message repository object 320.

In one embodiment, when the online instantiable message repository object 320 is created in association with the common file object 330, the online instantiable message repository management unit 420 may allow an online participant in the corresponding chat room to share the real-time operation of the corresponding file object 330. For example, in the case of the online instantiable message repository object 320 created in association with a specific common file object 330 corresponding to a document file, the online instantiable message repository management unit 420 may receive an operation sharing request or a real-time change sharing request for the document file from a specific online participant who is opening the corresponding chat room, may control the user terminal 120 of the requestor to manipulate the corresponding document file in real-time through at least a part of the interface of the chat room, and may control each user terminal 120 of other online participants who are opening the chat room to share the real-time operation situation including the operation processes and results in which specific contents are modified, added, and deleted in the document file by the corresponding requester through at least a part of the interface of the corresponding chat room or the real-time changes reflecting such results.

When the online instantiable message repository object 320 is successfully opened and a conversation message is added to the conversation thread, the conversation message management unit 430 updates the corresponding online instantiable message repository object 320. Here, the conversation message may include at least one of a message sender and a message content, and in one embodiment, may further include at least one of a message sending time and a message type (e.g., a common message, a work message, a multimedia message, etc.).

In one embodiment, when a conversation message is added, the conversation message management unit 430 may immediately provide the added conversation message to at least one participant related to the corresponding chat room, allowing the corresponding participant to internally open the corresponding online instantiable message repository object 320. For example, the conversation message management unit 430 may intermediately provide a corresponding added conversation message or notification message regarding the corresponding addition to each of participants other than participants immediately having confirmed the added conversation message and a message sender to allow the other remaining participants to perform an internal opening of the corresponding online instantiable message repository object 320 through a user response (e.g., clicking on the message) for the corresponding message. The management unit 430 may provide the number of unconfirmed conversation messages or unconfirmed online instantiable message repository objects 320 that are not confirmed by a user through a message unconfirmation count indicating information about a message that is not yet read by a user. In one embodiment, whenever a conversation message is added, the conversation message management unit 430 may detect the number of online instantiable message repository objects 320 including the unconfirmed conversation messages not confirmed by a user or the number of unconfirmed conversation messages not confirmed by a user, and may reflect the number of online instantiable message repository objects 320 or the number of unconfirmed conversation messages in the message unconfirmation count present in the corresponding folder object 310.

The conversation message management unit 430 may perform the message unconfirmation count on all of the folder object 310 and the sub-folder object 340 to provide to the user terminal 120, and accordingly, may display accumulated message unconfirmation count of the entire sub-structure of each folder object 310 through an unconfirmed count symbol in the process of visualizing, by the user terminal 120, the folder object 310 through the file sharing interface, and may also allow all sub-folder objects 340 in the sub-structure of the sub-folder object 340 to display the accumulated message unconfirmation count of its own entire sub-structure.

The conversation message management unit 430 may receive, as a conversation message, a transferred file object 324 transferred from one of at least one participant through the corresponding chat room. More specifically, the conversation message management unit 430 may add at least one transferred file object 324 transferred between participants through the chat room to the conversation thread of the corresponding online instantiable message repository object 320 as a conversation message. In one embodiment, the online instantiable message repository object 320 may include a container of transferred file object 324 and the corresponding conversation thread.

In one embodiment, the conversation message management unit 430 may automatically add the transferred file object 324 to the corresponding folder object 310 as a common file object 330, and may additionally associate the corresponding online instantiable message repository object 320 with the corresponding transferred file object 324. In this case, the conversation message management unit 430 may restrictively grant an access authority to access the added common file object 330 only to participants participating in the associated online instantiable message repository object 320, and may allow the unauthorized common file object 330 to be excluded from the file list in the process of visualizing the folder object 310 by the user terminal 120. In one embodiment, the conversation message management unit 430 may create a sub-folder object 340 associated with the corresponding online instantiable message repository object 320, and may automatically add the transferred file object 324 that is created through the corresponding online instantiable message repository object 320 to the sub-folder object 340 as the common file object 330. In this case, the conversation message management unit 430 may limit such that the online instantiable message repository object 320 needs to be used to add a specific file object to the corresponding sub-folder object 340.

The conversation message management unit 430 may receive, from the work creator corresponding to one of at least one participant through the corresponding chat room, a work object 322 which includes the work content and work processor and can be fed back by the corresponding work processor as a conversation message. In one embodiment, the online instantiable message repository object 320 may include a container of work object 322, a container of transferred file object 324 and the corresponding conversation thread.

More specifically, the conversation message management unit 430 may create the work object 322 including at least one of work contents, work creator, work processor, work rating and deadline based on a user request through the corresponding chat room, and may associate the work object 322 with the conversation thread of the instantiable message repository object 320. For example, the conversation message management unit 430 may add the work object 322 to the conversation thread as a work message. In one embodiment, the conversation message implemented through the chat room may include at least one of a text message, a work message, a multimedia message, and an attachment message.

The conversation message management unit 430 may add the work object 322 to the conversation thread as an independent work message that can be directly accessed in the corresponding room and is distinguished from the text message or the multimedia message. For example, each of the work objects 322 may be accessed as a work message by participants participating in the chat room in a conversation thread implemented with the chat room of the messenger, and may correspond to a work message object that is distinguished from a conversation message corresponding to a general text message and a media message such as a photograph or a video message.

Here, the work processor may correspond to a chat room participant who is designated as a target of processing the work by the work creator, and the work rating may include an evaluation reserve score indicating a maximum upper limit of the evaluation score that may be evaluated by the work creator when the work is completed, and an evaluation score indicating an actually evaluated score. Accordingly, the work creator may direct or evaluate a work in a way that communicates to the work processor through the work object 322 expressed as the work message in the chat room.

The conversation message management unit 430 may perform the progress of the work object 322 including the work progress state indicating the progress state by the processing phase, and may update the work object 322 by performing such progress based on the feedback by the work processor. In one embodiment, the conversation message management unit 430 may update a predetermined work progress state on the work processing diagram by reflecting a request by one of the work creator and the work processor and a response by the other, and then may update the corresponding conversation thread. For example, the work progress state may be ‘new’ indicating a state in which a work object 322 is newly created, ‘doing’ indicating a state in which the work processor is processing the work object 322, ‘done’ indicating a state of completion of the work object 322 by the work processor and waiting for interaction with the work creator about the work completion, and ‘confirmed’ indicating a state of having confirmed the completed work object 322 of the work processor by the work creator.

The conversation message management unit 430 may perform the progress of the work object 322 in a manner of updating the work progress state of the work object 322 through a work object-related response implemented with the response relationship between the work creator and the work processor. Here, the work object-related response corresponds to a response regarding the work object, which may be responded to by the user terminal 120 associated with the work creator or work processor, and in one embodiment, may include at least one of a work confirmation response, a work completion response, and a work evaluation response according to the current work processing state of the work object. For example, when the conversation message management unit 430 receives a work interaction corresponding to the work progress state of ‘new’ from a user corresponding to a work processor regarding the work object 322, the conversation message management unit 430 may update the corresponding work progress state to the state of ‘doing’ that is the next progress state.

In one embodiment, the conversation message management unit 430 may receive a work-related response from the user terminal 120 associated with the work creator or work processor through the control interface on the work object 322 in the message agent. When receiving the work object-related response, the conversation message management unit 430 may determine the current work processing state and update the corresponding conversation thread.

The conversation message management unit 430 may perform the progress of the work object 322, and may finally receive the evaluation about the work object 322 from the work creator to assign the evaluation as a work rating of the corresponding work object 322. For example, the conversation message management unit 430 may receive a work evaluation response that is one of the work object-related responses from the user terminal 120 associated with the work creator with respect to the work object 322 whose current work progress state is ‘done’, and may reflect the evaluation score included in the work evaluation response and designated by the work creator in the work rating of the work object 322.

In one embodiment, the conversation message management unit 430 may provide a remind message which is associated with the work object 322 via the conversation thread and requests completion of the corresponding work progress state according to a specific repetition criterion until the corresponding work progress state is completed. More specifically, the conversation message management unit 430 may detect at least one work object 322 that satisfies predetermined remind conditions in the work object set to create remind messages associated with each of the detected work objects 322. In one embodiment, the remind condition may be determined for each work progress based on the deadline or work importance specified by the work creator. The conversation message management unit 430 may add a remind message including the remind contents and the number of remind times to the conversation thread of the corresponding online instantiable message repository object 320 according to a specific repetition criterion (e.g., transfer at an interval of 12 hours). In one embodiment, the conversation message management unit 430 may change the work progress state of the corresponding work object 322 based on a response of the work processor to the remind message.

The conversation message management unit 430 may detect a work object that satisfies the remind conditions among all the work objects 322 of the online instantiable message repository object 320 in the folder object 310 at a specific time period, and may reflect the work object in a today work list of the corresponding folder object 310. The conversation message management unit 430 may detect all the work objects 322 satisfying the remind conditions among all the work objects 322 of the online instantiable message repository object 320 in the corresponding folder object 310 and the corresponding sub-structure at a specific time period to reflect the detection result in the today work list, and the detection may be performed on each of the folder objects 310 and sub-folder objects 340 to provide the today work list to the user terminal 120.

Accordingly, the conversation message management unit 430 may allow the user terminal 120 to display a remind work object list detected for the entire sub-structures of the corresponding folder object 310 through a today work list providing field of the file sharing interface, and all individual sub-folder objects 340 in the sub-structure of the folder object 310 may also display a remind work object list detected for the entire sub-structures thereof.

The conversation message management unit 430 may allow a statistic calculation result calculated based on at least one of the number of creations regarding all the online instantiable message repository objects 320, common file objects 330 and sub-folder objects 340 which have association of a subtree structure with the folder object 310, the creator, and the participant to be included in an accumulated statistic count in the corresponding folder object 310. In one embodiment, the conversation message management unit 430 may perform statistic calculation based on at least one of the number of creations, the number of processing, the work creator, and the work processor regarding the work objects 322 associated with all of the corresponding online instantiable message repository objects 320, and may reflect the statistic calculation result in the accumulated statistic count. For example, in regard to the corresponding folder object 310 and the entire sub-structure thereof, the conversation message management unit 430 may reflect how many online instantiable message repository objects 320 are present, how many work objects 322 are created therethrough, and how many transferred file objects 324 are shared among the participants in the accumulated statistic count of the folder object 310.

The conversation message management unit 430 may perform the calculation processing regarding this accumulated statistic count on each of the folder objects 310 and the sub-folder objects 340 to provide the calculation processing result to the user terminal 120.

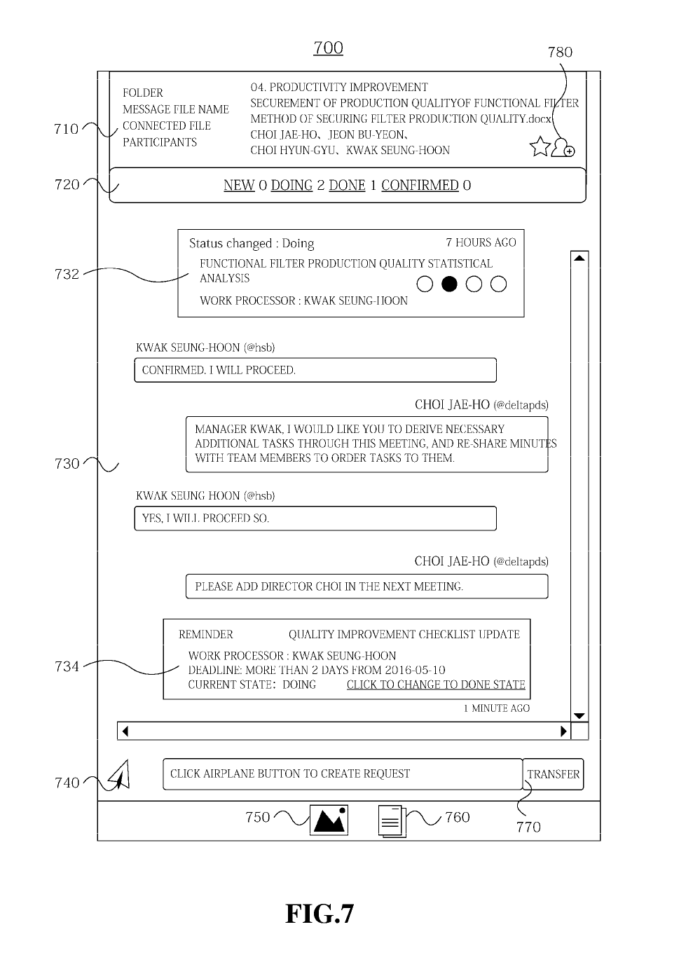

In one embodiment, the conversation message management unit 430 may determine the activity of the corresponding online instantiable message repository object 320 based on the update frequency of the conversation thread or the number of created work objects 322. For example, if the corresponding conversation thread is updated faster than a preset reference period, or if the message throughput processed during a specific time period is greater than a specific reference throughput, or if the number of the work objects 322 created through the conversation thread is larger than a specific reference number, then the activity may be determined as ‘high’ (see FIG. 7).

In one embodiment, the conversation message management unit 430 may calculate an activity index (a) of an online instantiable message repository object 320 based on Equation (1) below, and may determine the activity as a specific activity level according to the range of the calculated activity index (a). For example, the conversation message management unit 430 may calculate the activity index (a) of a specific online instantiable message repository object (e.g., the number of participants is 6, three work objects 322 are created, and the average message update frequency for the last three days is three hours) 320 as 6, and thus may determine the corresponding activity as ‘high’. For example, according to the calculated activity index (a), the conversation message management unit 430 may determine the activity as ‘very high’ if a<1, as ‘high’ if 1≤a<10, as ‘normal’ if 10≤a<25, as ‘low’ if 25≤a<50, and as ‘very low’ if a≥50.

$$a = \frac{u \times r}{w} \qquad ( 1 )$$

Here, r is an integer rounded up by a unit of time basis and denotes a time difference between the current time and the update time of the most recently updated conversation thread, w denotes the number of work objects 322 created through the conversation thread, and u denotes the number of participants participating in the chat room.

In one embodiment, the conversation message management unit 430 may allow the online instantiable message repository objects 320 in the folder object 310 to be sorted in ascending order of activity. The activities determined for each the online instantiable message repository object 320 are provided to the user terminal 120 such that the user terminal 120 sorts the online instantiable message repository objects 320 in the folder object 310 in ascending order of activity. In one embodiment, the conversation message management unit 430 may create metadata about the number of created work objects, the number of participants, and the latest update time of conversation thread for each online instantiable message repository object 320, and may perform sorting on all online instantiable message repository objects 320 in the folder object 310 based on the corresponding metadata.

The controller 440 may control the overall operation of the processor 210, and may control the data flow among the folder object management unit 410, the online instantiable message repository management unit 420, and the conversation message management unit 430.

FIG. 5 is a flowchart illustrating a message-based file sharing procedure performed by the processor of FIG. 2.

In FIG. 5, the folder object management unit 410 receives an open request for the online instantiable message repository object 320 that may be instantiated into a chat room participated by at least one participant and associated with the conversation thread, and may be implemented as a computer file (S510). The online instantiable message repository management unit 420 may receive an open request for the online instantiable message repository object 320.

The conversation message management unit 430 resumes the chat room when the online instantiable message repository object 320 is successfully opened (S520). In one embodiment, the conversation message management unit 430 may continue the existing chat room when the online instantiable message repository object 320 is opened by a new participant. That is, the conversation message management unit 430 may provide the conversation messages in the existing chat room to the new participant.

The conversation message management unit 430 updates the corresponding online instantiable message repository object 320 when a conversation message including the message sender and the message content is added to the chat room associated with the conversation thread (S530).

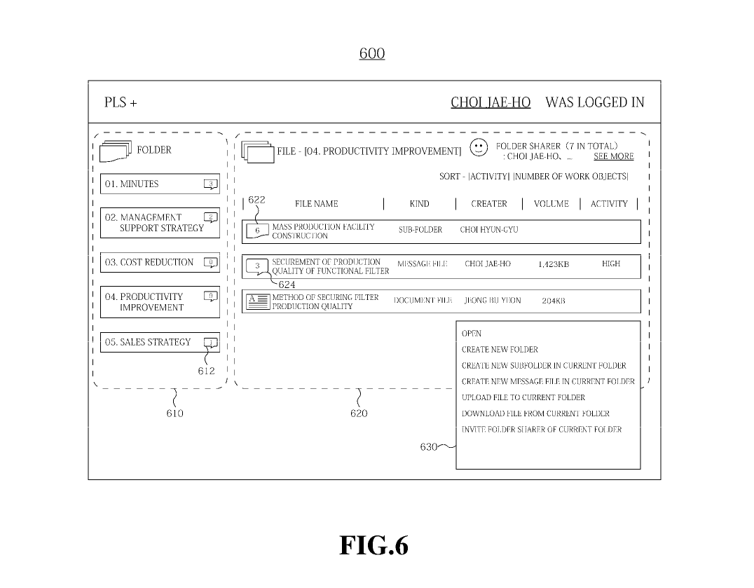

FIG. 6 is a view illustrating a process of providing, by a user terminal, a file sharing interface in linkage with an online instantiable message repository processing apparatus according to an embodiment of the present invention.

In FIG. 6, the online instantiable message repository processing apparatus 110 may provide information about the folder object 310 associated with a user to the user terminal 120, and thus may allow the user terminal 120 to display the corresponding folder object 310 through the file sharing interface 600 in the message agent installed in the corresponding user terminal 120. The online instantiable message repository processing apparatus 110 receives creation, modification and deletion requests regarding the folder object 310, the online instantiable message repository object 320, the common file object 330 and the sub-folder object 340 associated with a user via the file sharing interface 600, or receive an open request for a specific online instantiable message repository object 320. Also, the online instantiable message repository processing apparatus 110 may determine whether to allow access for the corresponding opening based on the user authority, and thus allow the user terminal 120 to instantiate the corresponding online instantiable message repository object 320 into a chat room.

The user terminal 120 may receive information on the folder object 310 associated with the corresponding user from the online instantiable message repository processing apparatus 110 and visualize the information through the folder display area 610. Accordingly, a user may check the list of all the folder objects 310 that a user can participate as the folder sharer through the folder display area 610, and may attempt to access a specific folder object 310 in the corresponding list. Also, the user terminal 120 may display a message unconfirmed count in the corresponding folder object 310 through the folder unconfirmed count symbol 612 for each folder object 310 and may inform a user of the number (e.g., nine in the case of ‘04. Productivity Improvement Folder’ that is the currently selected folder in FIG. 6) of unconfirmed conversation messages which are not confirmed by a user among all the online instantiable message repository objects 320 in the sub-structure of the corresponding folder object 310.

When the access attempt to a specific folder object 310 is allowed, the user terminal 120 may receive information on at least one of the online instantiable message repository object 320, the common file object 330 and the sub-folder object 340 in the corresponding specific folder object 310 from the online instantiable message repository processing apparatus 110 to visualize the file object list in the corresponding folder object 310 through the file display area 620, and may receive an access or open request regarding the specific file object through the corresponding file object list.

The user terminal 120 may display the file name, type, creator, capacity and activity of the corresponding file object through the file display area 620. In the case of the sub-folder object 340, the user terminal 120 may express the corresponding message unconfirmation count through the sub-folder unconfirmation count symbol 622 to inform a user of the number of a unconfirmed conversation messages which are not confirmed by a user among all the instantiable message repository object 320 in the sub-structure of the corresponding sub-folder object 340. In the case of the online instantiable message repository object 320, the user terminal 120 may display the corresponding message file unconfirmation count through the message file unconfirmation count symbol 624.

The user terminal 120 may receive a new online instantiable message repository creation request in the corresponding folder object 310 through a folder control interface 630 under the control of a user to send the corresponding request to the online instantiable message repository processing apparatus 110, and may allow the online instantiable message repository processing apparatus 110 to invite a designated user among the folder sharers in the process of newly creating an online instantiable message repository object 310 by the online instantiable message repository processing apparatus 110. In addition, the user terminal 120 may send an open request of the corresponding online instantiable message repository object 320 to the online instantiable message repository processing apparatus 110 when a specific online instantiable message repository object 320 is selected through a file display area 620.

For example, the user terminal 120 may provide a folder control interface 630 when a user input such as an empty space touch input or a mouse right click is received by a user through the file display area 620, and may receive a user request for creating a new sub-folder object (creating new folder), creating a new sub-folder object (creating a new sub-folder in the current folder), creating a new online instantiable message repository (creating a new message file in the current folder), transferring a new common file object (uploading a file in the current folder), receiving a specific file object (downloading a file in the current folder), or adding a folder sharer (inviting a folder sharer in the current folder) via interface 630.

In addition, for example, the user terminal 120 may provide a folder control interface 630 based on the corresponding file object when receiving a user input such as a long touch input or a mouse right click over a specific time for a specific file object of the file display area 620, and may receive a user request for opening of the corresponding through the folder control interface 630. When the corresponding file object corresponds to the online instantiable message repository 320 (e.g., a message file of ‘secure production quality of functional filter’), the user terminal 120 may receive a user request for opening of the corresponding file through the folder control interface 630, and when the corresponding file object corresponds to the common file object 330 (e.g., a document file of ‘method of securing filter production quality’), the user terminal may receive a user request for creation of a new online instantiable message repository associated with the common file object 320 through the folder control interface 630.

FIG. 7 is a view illustrating a process of visualizing, by a user terminal, an online instantiable message repository to a chat room in linkage with an online instantiable message repository processing apparatus.

In FIG. 7, the online instantiable message repository processing apparatus 110 may allow an open request from a user terminal 120 when receiving the open request for a specific online instantiable message repository object 320 with which a user is associated as a participant. Thus, the user terminal 120 may access the corresponding online instantiable message repository object 320 to visualize the corresponding online instantiable message repository object 320 through the message file interface 700. The online instantiable message repository processing apparatus 110 may update the corresponding online instantiable message repository object 320 whenever the conversation message between participants via the message file interface 700 is received.

A message file interface 700 includes a message file main information display field 710, a work object progress state display field 720, a message display field 730, a work object creation button 740, a multimedia upload menu 750, a file upload menu 760, a chatting message input field 770, and a user invitation menu 780.

The user terminal 120 may display the folder name in which the corresponding online instantiable message repository object 320 is located, the corresponding file name, the presence or absence of the associated common file object (if present, the associated file name is provided), and the participants through the message file main information display field 710. The user terminal 120 may display the number of creations for each work progress state (new, doing, done, and confirmed) of the work object 322 created via the corresponding conversation thread through the work object progress state display field 820, and may support access to the corresponding work object 330 according to a user input through the message file main information display field 710.

The user terminal 120 may provide a work object 322 expressed as a work message and a general chatting message expressed as a text message through a message display field 730. For example, the work object 322, like an identification number 732, and may be expressed as an independent work message that is distinguished from a general chatting message or a multimedia message, and the user terminal 120 may display at least one of work content, work creator, work processor, and work progress state of each work object 322 (in FIG. 7, the current work progress state can be expressed symbols such as new (●◯◯◯), doing (◯●◯◯), done (◯◯●◯), or a confirmed (◯◯◯●). The current work progress state may be indicated through the symbol corresponding to the processing step). Also, the user terminal 120 may provide a remind message through the message display field 730. For example, in the case of a specific work object 322 that is determined to be reminded by the online instantiable message repository processing apparatus 110, a remind message including information (work processor, deadline, and current work progress state of the corresponding work object 322) about the reminded target and a state change button (which can be changed from ‘doing’ state to ‘done’ by the work processor) by which the current work progress state of the corresponding work object 330 can be changed to the next stage may be provided as shown in the identification number 734.

The user terminal 120 receives a work object creation request including information on the work creator, the work processor, the work content, and work rating through the work object creation button 740, and transfers the work object creation request to the online instantiable message repository processing apparatus 110. Accordingly, the online instantiable message repository processing apparatus 110 may create a work object 322 based on the received work object creation request and add the work object 322 to the corresponding conversation thread as a work message, and similarly to the identification number 732, the user terminal 120 may visualize the work object 322 in the chat room as a work message.

The user terminal 120 may receive an upload request for a multimedia file or an attachment file through each of the multimedia upload menu 750 and the file upload menu 760, and may receive a transferred file object 324 from a user to add the transferred file object 324 to the conversation thread as a conversation message such as a multimedia message or an attachment message.

The user terminal 120 may receive a conversation from the user through the conversation message input field 770 and send the conversation to the online instantiable message repository processing apparatus 110. The online instantiable message repository processing apparatus 110 may add the transferred conversation to the corresponding conversation thread as a conversation message, and may update the corresponding online instantiable message repository object 320 in real-time.

The user terminal 120 may receive user invitation information including at least one invitation target designated by a user among the folder sharers related to the folder object 310 through the user invitation menu 780, and may transfer the user invitation information to the online instantiable repository processing apparatus 110. The online instantiable message repository processing apparatus 110 may perform user invitation based on the received user invitation information, and may associate the corresponding invitation targets with the corresponding online instantiable message repository object 320 as participants.

The disclosed technology may have the following effects. However, since it is not meant that a specific embodiment should include all of the following effects or includes only the following effects, the right scope of the disclosed technology should not be construed as limited thereby.

An online instantiable message repository processing apparatus and method according to an embodiment of the present invention can efficiently share the overall communication process between users through a repository that can be instantiated as an online chat room and stores past messages.

An online instantiable message repository processing apparatus and method according to an embodiment of the present invention can allow a new participant or an old participant who has left a chat room to access a computer file and to easily participate in a chat room including all of past conversation messages through an online instantiable message repository.

An online instantiable message repository processing apparatus and method according to an embodiment of the present invention can increase user convenience by applying an online instantiable message repository managed as a computer file that can be shared between users and thus allowing a chat room to be shared and managed through a more intuitive interface.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An online instantiable message repository processing apparatus comprising a memory and a processor electrically connected to the memory,
wherein the processor:
receives an open request of an online instantiable message repository which is instantiable into a chat room participated by at least one participant and associated with a conversation thread and implemented as a computer file;
resumes the chat room when the online instantiable message repository is successfully opened; and
updates the online instantiable message repository when a conversation message comprising a message sender and a message content is added to the chat room associated with the conversation thread.

2. The apparatus of claim 1, wherein the processor grants a file control authority of the online instantiable message repository to a chat room creator.

3. The apparatus of claim 2, wherein the processor grants a file read authority of the online instantiable message repository to the at least one participant participating via the online invitation.

4. The apparatus of claim 2, wherein the processor manages a folder object comprising the online instantiable message repository together with a common file object as a shared folder of the at least one participant.

5. The apparatus of claim 1, wherein the processor requests the chat room creator to approve deletion of the online instantiable message repository when participation of all the participants in the chat room is terminated.

6. The apparatus of claim 1, wherein the processor determines whether or not a requester corresponds to one of the at least one participant and approves the open request when the open request is received.

7. The apparatus of claim 6, wherein the processor reverse-sequentially provides a portion of the conversation threads to the corresponding requester at a specific time interval unit in the online repository capable message repository when the open request is approved.

8. The apparatus of claim 1, wherein the processor allows the at least one participant to share real-time manipulation or real-time modification of a common file object when a conversation message in the conversation thread is associated with the common file object.

9. The apparatus of claim 1, wherein when the conversation message is added, the processor immediately provides the added conversation message to the at least one participant such that the participant internally opens the online instantiable message repository.

10. The apparatus of claim 1, wherein whenever the conversation message is added, the processor reflects the number of online instantiable message repositories comprising unconfirmed conversation messages not confirmed by a user among all online instantiable message repositories in the corresponding folder object and the sub-folder object thereof or the number of unconfirmed conversation messages not confirmed by a user in the folder object.

11. The apparatus of claim 1, wherein the processor receives a transferred file object transferred from one of the at least one participant through the chat room as the conversation message.

12. The apparatus of claim 11, wherein the processor automatically adds the transferred file object to a corresponding folder object as a common file object and associates the conversation message with the transferred file object.

13. The apparatus of claim 11, wherein the processor receives, from a work creator corresponding to one of the at least one participant through the chat room, a work object comprising a work content and work processor and fed back by the work processor as the conversation message.

14. The apparatus of claim 13, wherein the processor detects a work object satisfying a remind condition among the work objects of all online instantiable message repositories in the folder object at a specific time period and reflects the work object in a today work list in the folder object.

15. The apparatus of claim 1, wherein the processor allows a statistic calculation result calculated based on at least one of the number of creations regarding all the online instantiable message repositories, common file objects and sub-folder objects which have association of a subtree structure with a folder object, the creator, and the participant to be comprised in an accumulated statistic count in the corresponding folder object.

16. The apparatus of claim 15, wherein the processor performs statistic calculation based on at least one of the number of creations, the number of processing, the work creator, and the work processor regarding the work objects associated with all of the corresponding online instantiable message repositories, and reflects a statistic calculation result in the accumulated statistic count.

17. The apparatus of claim 1, wherein the processor determines the activity of the online instantiable message repository object 320 based on the update frequency of the conversation thread or the number of created work objects to determine the sorting order of the online instantiable message repository in the corresponding folder object.

18. The apparatus of claim 1, wherein when receiving a delete request for a common file object from a folder sharer regarding a folder object, the processor approves the delete request based on the association with the online instantiable message repository in the corresponding folder object and the common file object.

19. The apparatus of claim 1, wherein when a move request from the corresponding folder object (hereinafter, referred to as a first folder object) to another folder object (hereinafter, referred to as a second folder object) with respect to the online instantiable message repository, the common file object, or the sub-folder object is received, the processor re-associates a target object requested to move and all other objects associated therewith with the first and second folder objects.

20. A method of processing an online instantiable message repository performed in an online instantiable message repository processing apparatus comprising a memory and a processor electrically connected to the memory, the method comprising:
receiving an open request of an online instantiable message repository which is instantiable into a chat room participated by at least one participant and associated with a conversation thread and implemented as a computer file;
resuming the chat room when the online instantiable message repository is successfully opened; and
updating the online instantiable message repository when a conversation message comprising a message sender and a message content is added to the chat room associated with the conversation thread.
